(19) United States
(12) Patent Application Publication
(10) Pub. No.: US 2017/0261261 A1
(43) Pub. Date: Sep. 14, 2017

(54) DRYER CONTROL BY REGULATION OF HOT AIR SUPPLY RATE

(71) Applicant: Stephen B. MAGUIRE, West Chester, PA (US)

(72) Inventor: Stephen B. MAGUIRE, West Chester, PA (US)

(21) Appl. No.: 15/457,051

(22) Filed: Mar. 13, 2017

Related U.S. Application Data
(60) Provisional application No. 62/307,945, filed on Mar. 14, 2016.

(51) Int. Cl. F26B 21/12; F26B 17/14; F26B 3/06

(52) U.S. Cl. CPC F26B 21/12; F26B 3/06; F26B 17/14; F26B 2200/08

(57) ABSTRACT

Method and apparatus for hot air drying granular polymeric resin material records heating air temperature at a heating air outlet, computes air flow rate through a hopper, maintains desired throughput of granular material being dried in the hopper until heating air outlet temperature is stable, and thereafter maintains air flow rate through the hopper and monitors that air flow rate to adjust the air flow rate to maintain a computed preferred air flow rate through the heating hopper.

This patent application claims the benefit of the priority of U.S. provisional application Ser. No. 62/307,945 filed 14 Mar. 2016 in the name of Stephen B. Maguire and entitled “Resin Dryer Control by Regulation of Hot Air Supply Rate.” The priority of the '945 application is claimed under 35 USC 120.

### INCORPORATION BY REFERENCE

This patent application incorporates by reference the disclosure of U.S. Pat. No. 8,141,270 B2 issued 27 Mar. 2012 and entitled “Gas Flow Rate Determination Method and Apparatus and Granular Material Dryer and Method for Control Thereof.” This patent application further incorporates by reference the disclosure of United States patent publication US 2015/0316320 A1, published 5 Nov. 2015 and entitled “Method and Apparatus for Vacuum Drying Granular Resin Material.”

### STATEMENT REGARDING FEDERAL FUNDING FOR THIS INVENTION AND TECHNOLOGY

Not applicable.

### BACKGROUND OF THE INVENTION

Field of the Invention

This invention relates generally to dryers using hot air to dry granular material. Such dryers are widely used in the course of fabrication of plastic products by molding and extrusion, as well as in other industrial processes throughout the world.

Description of Prior Art Practice and Issues Addressed by the Invention

Hot air dryers for granular material typically have a hopper in which the granular material is dried, with hot air usually being introduced into the hopper close to the hopper bottom and with the heating air usually exiting from the hopper close to or at the top of the hopper. A blower is typically provided to force the hot air through the granular material in the hopper.

Dryers for granular material generally seek to reduce energy usage by monitoring the hopper exit air temperature, and if higher than desired exit air temperatures are detected, the blower speed is reduced to slow the air flow. This reduces the energy available (BTU's) to heat the granular material, which results in the granular material heating more slowly and the exit air temperature dropping.

There is a drawback in reducing air flow to lower exit air temperature in such dryers. Variations in air flow rate result in variations in drying capacity. Reduction in air flow rate, conventionally measured in cubic feet per minute (sometimes abbreviated “CPM” herein) may also disrupt desired laminar heating air flow in the hopper, resulting in air channels developing in the granular material in the hopper. Such air channels cause uneven drying of the granular material.

In such dryers, the heating air is not only heating the granular material; the heating air is also the vehicle by which moisture is removed from the granular material. This second function can be compromised by reducing air flow.

Adding cold granular material into the hopper at the top immediately reduces temperature of heating air exiting the hopper. High heating air exit temperatures are typically construed to mean the air flow rate is higher than necessary, with energy being wasted. Since wasting energy is to be avoided, blower speed is usually reduced. Conversely, a drop in temperature of heating air exiting the hopper is construed to mean that air flow rate is too low, so blower speed is increased to produce a higher heating air flow rate, to deliver more heat to the granular material.

This conventional response is not the correct response. Simply allowing time to pass soon results in heating air exit temperature rising again, as the newly added cold granular material is heated.

Process conditions not related to blower speed can cause changes in heating air flow rates. A hopper that becomes partially empty offers less back pressure, and therefore draws more heating air flow. Dusty granular material that packs tightly together in the hopper creates more back pressure thereby reducing blower speed and hence heating air flow rate.

### DESCRIPTION OF THE INVENTIVE CONCEPTS EMBODIED IN THE INVENTION

This invention addresses the issues noted above. One aspect of the invention involves varying blower speed in order to hold air flow rate through the hopper essentially steady, instead of targeting temperature of heating air exiting the hopper as the controlling factor. Ideal air flow rate through the hopper is generally directly related to the granular material throughput rate. Specifically, there is a correct, theoretically ideal, air flow rate through a given hopper for a given granular material throughput rate. In the case of drying most granular polymeric resin materials, that value has been found to be about six tenths (0.6) cubic feet per minute of air for every pound per hour of granular polymeric resin material being dried.

This invention may be used with all types and kinds of granular materials but is particularly well adapted for drying granular polymeric materials, specifically granular polymeric resin materials.

With a known throughput of granular material, ideal air flow rate in CFM can be calculated and controlled by continuously monitoring the air flow rate in CFM, and adjusting the dryer blower speed to maintain the correct, ideal air flow rate. Generally driers are designed and supplied with an air flow rating in CFM corresponding to the maximum granular material throughput rate for the dryer. The blower for a given dryer is sized to provide the desired air flow rate in CFM at the maximum granular material throughput rate. However, in practice dryer blowers are nearly always oversized to provide a margin of safety. As a result, if the dryer blower has no feedback control, or is a fixed speed blower, during dryer operation the blower will always be delivering more air in CFM than is necessary, resulting in excess energy consumption by the dryer.

One way this excess dryer capacity issue is addressed by the invention is to provide the blower with a variable speed control. The invention in one of its method aspects monitors hopper exit air temperature, and reduces the blower speed to deliver only the volume of heating air required to impart the required heat to the resin, which heat is furnished at a rate matching the granular material throughput rate. Within this approach, a higher than preferable temperature of the air exiting the hopper signifies that the air flow rate, as supplied by the blower, is too high.

A problem with monitoring hopper heating air exit temperature and adjusting blower speed downwardly if the hopper heating air exit temperature is too high, but increasing blower speed if the hopper heating air exit temperature is too low, is that the hopper heating air exit temperature changes suddenly when new, cold granular material is added to the hopper to be dried. Heating air exit temperature is one, but not the preferred, feedback parameter used for control of the dryer.

Hopper heating air exit temperature is also a variable that may be controlled. In another one of its aspects the invention controls hopper heating air exit temperature, most preferably over a relatively long time horizon. In this one of its aspects, the invention controls heating air exit temperature by making preferably minor, preferably long term adjustments in the ratio of air flow rate in cubic feet per minute to pounds of granular material throughput and adjusting blower speed as needed, based on monitoring of the hopper heating air exit temperature.

The ratio of air flow rate in cubic feet per minute to granular material throughput rate in pounds per minute of 0.6 is a value experience has shown to satisfactorily heat nearly all granular polymeric resin materials, without wasting heat.

If measured hopper exit air temperatures are, on average, higher than what is known to be desirable, then the ratio of cubic feet per minute of air flow per pound of granular polymeric material throughput per minute is incorrect and heat is being wasted.

In one of its aspects the invention desirably monitors the hopper heating air exit temperature and in response to that, makes small, gradual adjustments to the ratio of air speed in cubic feet per minute to throughput of granular material in pounds per minute (which ratio is otherwise a constant in software executed by microprocessor), so that on average the invention results in holding the correct, desired hopper heating air exit temperature while also maintaining a uniform air flow rate during normal minute-by-minute and hour-by-hour process variations.

In yet another aspect of the invention, the microprocessor monitors air flow, usually measurable in cubic feet per minute, through the hopper, and if a change in the air flow rate is detected, the microprocessor adjusts blower speed to return to the previously set optimum ratio of air flow in cubic feet per minute to granular material throughput in pounds per minute. Then as the microprocessor continues to monitor hopper exit air temperature, the microprocessor (or other functionally equivalent electronic data processing device) gradually “learns” whether the ratio of air flow rate to granular material throughput is correct. Detection of excess heat, in the form of higher hopper heating air exit temperature occurring over time, by the microprocessor allows the microprocessor to gradually reduce the ratio of air flow rate to granular material throughput. This results in the microprocessor reducing blower speed, while still maintaining uniform ratio of air flow rate to granular material throughput.

During startups and during material changeovers, the microprocessor preferably makes the blower speed change rapidly, to hold a target ratio of air flow rate to granular material throughput. The target air flow rate to granular material throughput ratio is preferably adjusted gradually, sometimes over a period of several hours, to maintain the desired average hopper heating air exit temperature.

This additional process control concept utilizes a microprocessor using feedback information to make adjustments to blower speed. Heat input is adjusted by the microprocessor preferably to hold inlet heating air temperature constant and preferably below a maximum allowable temperature. If hopper heating air inlet temperature is too high, the granular material to be dried can be damaged and become unusable.

Adjustment to blower speed by the microprocessor preferably occurs only after a steady temperature of the heating air exiting the hopper is being maintained. Then the ratio of air flow rate to granular material throughput is calculated, preferably by the microprocessor, and blower speed is altered, preferably by the microprocessor, in small increments, preferably with corresponding heater power adjustments to affect the inlet air temperature to bring the ratio of air flow rate to granular material throughput back to the target ratio. Over time, if exit air temperature reaches higher than desired levels, or never reaches the minimum level required for effective drying, the target ratio of air flow rate to granular material throughput is adjusted preferably incrementally by the microprocessor until hopper heating air exit temperatures fall into line with expectations.

This invention provides a method for hot air drying of granular material, preferably but not exclusively granular polymeric resin material, such as polymer resin material to be molded or extruded into plastic products. The method in one part includes the steps of selecting a desired granular material throughput rate, selecting a desired input heating air temperature, using the selected granular material throughput rate to calculate the air flow rate required to deliver sufficient heat to the granular material to raise the temperature exiting the granular material to a level at which the granular material is adequately dry, monitoring the temperature of heating air leaving the granular material, drying the granular material by blowing heating air therethrough at the calculated air flow rate until the temperature of heating air leaving the granular material is steady and preferably within a preselected range, determining rate of heating air flow through the granular material from the temperature of heating air leaving the granular material, and adjusting air flow rate until actual heating air flow rate through the granular material equals the calculated heating air flow rate. In this part the invention may further include continuously monitoring temperature of heating air leaving the granular material and preferably incrementally adjusting heating air flow rate if temperature of heating air leaving the granular material is outside a pre-selected range, until temperature of heating air leaving the granular material is within the pre-selected range.

In another of its parts, this invention provides a dryer for granular materials, including granular polymeric material and granular polymer resin material that may be molded or extruded into plastic products. The dryer in this part of the invention preferably includes a heating hopper having a granular material inlet and a heating air outlet, both located proximate to the heating hopper top. The heating hopper further preferably includes a granular material outlet and a heating air inlet, both located close to the hopper bottom. The dryer preferably further includes a blower and a conduit that connects output from the blower to the heating air inlet in the hopper. A first heater is preferably provided in the conduit. An inlet air temperature sensor is preferably located in the conduit between the heater and the hopper. An air speed detector, which includes a heating air outlet temperature sensor, is provided preferably in the heating air outlet. A scale detects weight of heated granular material exiting the hopper via the granular material outlet. A transformer is preferably connected to the heater for furnishing electrical power thereto. The dryer further includes a microprocessor preferably connected to the blower, the transformer, the temperature sensor, the scale and the air speed detector, for controlling blower speed and, in response to detected air speed, maintaining exit air temperature at a selected optimum resulting in minimal energy usage by the heater. In this part of the invention, the air speed detector for the dryer preferably further includes a second outlet air temperature sensor and a heater positioned between the two outlet air temperature sensors.

In yet another part of the invention, there is provided a method for hot air drying of granular polymeric material where the method includes setting an input air temperature control to a desired drying temperature for the granular polymeric material to be dried, selecting a desired throughput of granular polymeric material to be dried in pounds per hour, blowing air at the desired drying temperature and at a selected air flow rate into the bottom of the hopper in which the granular polymeric material is to be dried, monitoring the temperature of air exiting the hopper, checking the granular polymeric material exiting the hopper for moisture and if found to be too moist, incrementally increasing the air flow rate into the bottom of the hopper until moisture level in the granular material exiting the hopper is at the desired level. The method preferably proceeds by recording exit air temperature and computing air flow rate, and maintaining desired throughput of granular material being dried in the hopper until exit air temperature is stable. The method preferably then records the exit air temperature at the stable condition and preferably incrementally reduces air flow rate until temperature of air exiting the hopper falls below the recorded exit air temperature at the stable condition. The method then proceeds by preferably incrementally increasing air flow rate until exit air temperature returns to the recorded exit air temperature at the stable condition. The method preferably then further proceeds by computing air flow rate at this condition and preferably yet further proceeds by continuously monitoring air flow rate for variance from the computed air flow rate at the stable condition and adjusting air flow rate to return to what the air flow rate was at the stable condition. The method preferably then proceeds by continuously monitoring exit air temperature and if exit air temperature is outside a predetermined range, repeating the steps of continuously monitoring the air flow rate for variance from the stable air flow rate condition and adjusting air flow rate to return to that air flow rate at the stable condition until exit air temperature is within the predetermined range.

In this method part of the invention, the selected air flow rate is desirably computed as 0.6 cubic feet per minute per pound per hour when granular polymeric resin material is to be dried.

In this method part of the invention, granular material to be dried is preferably introduced into the top of the hopper and the dried granular material is received preferably from the bottom of the hopper. The temperatures are sensed and air flow rates are preferably controlled by a microprocessor. In the practice of this method, the desired throughput of granular material being dried in the hopper is preferably maintained once the stable exit air temperature condition has been reached.

In this method part of the invention, the method preferably further includes continuously introducing granular polymeric material into the hopper at the desired rate of throughput of polymeric material and releasing the heated granular polymeric material from the hopper at the desired throughput rate so as to provide continuous uniform flow of polymeric material through the hopper as the method is practiced.

In another part of the invention, there is provided a method for hot air drying granular material in a hopper having a granular material inlet and a heating air outlet at the hopper top, and a granular material outlet and a heating air inlet at the hopper bottom. In this part of the invention, the method includes recording heating air temperature at the heating air outlet, computing heating air flow rate through the hopper, maintaining a desired throughput of granular material being dried in the hopper until the heating air outlet temperature is stable, recording the stable heating air outlet temperature, incrementally reducing air flow rate through the hopper until the heating air outlet temperature falls below the stable heating air outlet temperature as recorded, incrementally increasing air flow rate until heating air outlet temperature returns to the stable heating air outlet temperature condition, computing air flow rate through the hopper, continuously monitoring air flow rate through the hopper for variance from the rate at the heating air outlet stable temperature condition, and adjusting the air flow rate through the hopper to return to the computed desired air flow rate. The method further preferably continuously monitors heating air outlet temperature and if heating air outlet temperature is outside a predetermined range, repeating the monitoring of the air flow rate and adjusting the air flow rate through the hopper to return to the air flow rate at the stable condition until heating air outlet temperature is within a predetermined range of the stable condition heating air outlet temperature. In this part of the invention the method may yet further include maintaining a desired throughput of granular material being dried in the hopper while performing the steps noted immediately above.

### DESCRIPTION OF THE DRAWING

FIG. 1 is a schematic representation of a granular material dryer manifesting aspects of the invention.

### DETAILED DESCRIPTION OF THE INVENTION

In this description of the invention, the description is in terms of drying granular polymeric resin materials. However, the invention is not limited to drying granular polymeric resin material. Any granular material may be dried using the invention.

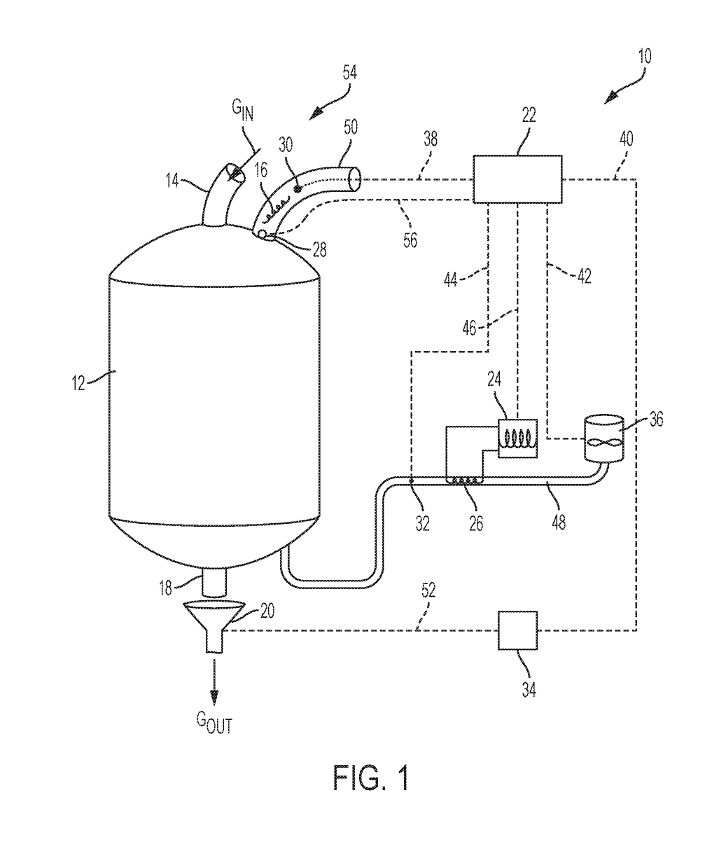

Referring to the drawing, a dryer 10 for drying granular polymeric resin material and embodying aspects of the invention is illustrated schematically in FIG. 1. In FIG. 1 hopper 12 is a part of dryer 10 for drying granular polymeric resin material. A hot air outlet conduit, connected to hopper 12 for hot air exiting hopper 12, is denoted 50. Within hot air outlet conduit 50 is an air speed detector 16 for detecting speed of air exiting hopper 12 via hot air outlet conduit 50.

A microprocessor 22 controls a blower 36 and a transformer 24. Microprocessor 22 connects to blower 36 via a blower control line 42. Microprocessor 22 connects to transformer 24 via a transformer control line 46. Microprocessor 22 further connects to a temperature sensor 32, which is resident within a hot air supply line 48, via connecting signal line 44. Microprocessor 22 further connects to a scale 34 via a connecting signal line 40. Scale 34 receives readings from a weight sensor denoted 20 in FIG. 1 via a connecting line signal 52.

Granular polymeric resin material to be dried enters hopper 12 via granular polymeric resin material inlet conduit 14 located at the top of hopper 12. Granular polymeric resin material that has been dried exits hopper 12 downwardly through granular polymeric resin material outlet conduit 18. Granular polymeric resin material supplied to dryer 10 and entering hopper 12 via granular polymeric resin material inlet conduit 14 will typically have come from a gravimetric blender in which virgin resin material, recycled resin material, colorant and other additives to facilitate molding or extrusion of the granular polymeric resin material, if the granular polymeric resin material is thermoplastic resin, have been added according to a pre-determined recipe and mixed. Granular polymeric resin material exiting hopper 12 downwardly through granular polymeric resin material outlet conduit 18 will typically be conveyed to a receiver which acts as a temporary storage receptacle for the granular polymeric resin material, where the granular polymeric resin material stays until it is needed for molding or extrusion by an injection molding press or an extruder.

In operation, granular polymeric resin material is fed into hopper 12 as indicated by the upper arrow Gᵢₙ at granular polymeric resin material inlet conduit 14. Heating air for drying the granular polymeric resin material is supplied via hot air supply line 48 with the air being driven by blower 36 and heated by heater 26, both illustrated schematically in FIG. 1. The heating hot air enters hopper 12 close to the lower extremity of hopper 12 as illustrated in FIG. 1 where hot air supply line 48 terminates at hopper 12. Positioned within hot air supply line 48 is a temperature sensor 32 which connects to microprocessor 22 via a connecting line 44. Inlet air temperature sensor 32 senses the temperature of heating air supplied to granular polymeric resin material within hopper 12 via hot air supply line 48 with heated air temperature sensor 32 supplying the sensed temperature to microprocessor 22 via a connecting line 44.

Microprocessor 22 controls operation of blower 36 and operation of transformer 24. Transformer 24 supplies electrical current at a desired voltage and amperage to heater 26 as illustrated in FIG. 1 with the amperage and voltage being output by transformer 24 being regulated by microprocessor 22.

An outlet airspeed detector for detecting airspeed within hot air outlet conduit 50 is designated generally 54 in the drawing and includes an upstream outlet air temperature sensor 28 located within hot air outlet conduit 50, a downstream outlet air temperature sensor 30 also located within hot air outlet conduit 50 and a heater 16 which forms a portion of outlet airspeed detector 54. Outlet air speed detector 54 determines rate of air flow independently of the diameter or cross-sectional area of hot air outlet conduit 50. This is effectuated by measuring air temperature at a first position along conduit 50 with such air temperature being measured by upstream outlet air temperature sensor 28. Air flowing through conduit 50 out of hopper 12 and past upstream outlet air temperature sensor 28 is heated by heater portion 16 of outlet airspeed detector 54. The temperature of the flowing air is then measured at a second, downstream position within hot air outlet conduit 50 by downstream outlet air temperature sensor 30. Air temperature measured by downstream outlet air temperature sensor 30 is subtracted from measured air temperature ascertained by upstream outlet air temperature sensor 28 to obtain a temperature difference. The power used by heater portion 16 to heat the air flowing through hot air outlet conduit 50 is divided by the product of the measured temperature difference and the specific heat of air to provide the air flow rate through hot air outlet conduit 50. This type of airspeed detector 54 and the operation thereof is disclosed and described in more detail in U.S. Pat. No. 8,141,270, the disclosure of which has been incorporated by reference.

During start up, calibration, and production operation of dryer 10, hot air supplied to the bottom of hopper 12 by line 48, with that air being pushed by blower 36 and heated by heater 26, has its temperature measured continuously by inlet heating air temperature sensor 32, with the measured temperature data being supplied to microprocessor 22 via connecting signal line 44. Microprocessor 22 works with inlet heating air temperature sensor 32, heater 26, blower 36, and hot air supply line 48 to assure that the temperature of the hot air supplied to the granular polymeric resin material, to be dried by dryer 10 within hopper 12 never exceeds a maximum temperature, which is typically furnished by the manufacturer of the polymeric resin. (Polymer manufacturers usually provide ideal drying temperatures and other data for their product).

Respecting representative particular polymers that may be dried using the apparatus and method of the invention, for acrylonitrile butadiene styrene (ABS) the preferred and maximum drying temperature is 190° F.; for polyamide (PA) the preferred and maximum drying temperature is 190° F.; for polybutylene terephthalate (PBT) the preferred and maximum drying temperature is 250° F.; for polycarbonate (PC) the preferred and maximum drying temperature is 250° F.; for polyether ether ketone (PEEK) the preferred and maximum drying temperature is 300° F.; for polyethylene imine (PEI) the preferred and maximum drying temperature is 300° F.; for polysulfone (PSU) the preferred and maximum drying temperature is 300° F.; for polyurethane (PUR) the preferred and maximum drying temperature is 280° F.; for polyethylene terephthalate (PET) the preferred and maximum drying temperature is 300° F.; for poly(p-phenylene oxide) (PPO) the preferred and maximum drying temperature is 250° F.; and for polyphenylene sulfide (PPS) the preferred and maximum drying temperature is 300° F.

In one practice of the method for hot air drying granular polymeric material according to the invention, an input air temperature control portion of microprocessor 22 is set to a desired maximum drying temperature for the particular granular polymeric resin material to be dried. Next, a desired rate of throughput of granular polymeric resin material to be dried is selected, with that throughput rate typically being in pounds per hour. Microprocessor 22 actuates blower 36, transformer 24 and heater 26 so that blower 36 proceeds to blow air at the desired drying temperature and at a selected air flow rate through hot air supply line 48 into the bottom of hopper 12, all as illustrated in FIG. 1.

In this practice of the invention, microprocessor 22 monitors temperature of air exiting hopper 12 with that temperature information being supplied to microprocessor 22 by connecting signal line 56. Signal line 56 receives temperature data from upstream outlet air temperature sensor 28 and provides that data to microprocessor 22. It is to be understood that the temperature of the outlet air leaving hopper 12 via hot air outlet conduit 50 could equally be provided to microprocessor 22 by downstream outlet air temperature sensor 30 with an appropriate adjustment being made for the difference between temperatures as sensed by upstream outlet temperature sensor 28 and downstream outlet temperature sensor 30 according to the amount of electrical power furnished to heater 16 of outlet air speed detector 54, or heater 16 could be turned “off” as needed, whereupon the temperatures sensed by sensors 28 and 30 would be the same

Heater 16 receives power from transformer 24; the electrical lines connecting heater 16 and transformer 24 have not been illustrated in FIG. 1 to aid the clarity of the drawing.

As the drying method proceeds, granular polymeric resin material exiting hopper 12 via granular polymeric resin material outlet conduit 18 at the bottom of hopper 12 is tested for moisture. If the granular polymeric resin material exiting hopper 12 via granular polymeric resin material outlet conduit 18 is found to be excessively moist, microprocessor 22, having been appropriately programmed, incrementally increases the hot air flow rate into the bottom of hopper 12, with such hot air being supplied via hot air supply line 48 until moisture level in the granular polymeric resin material exiting hopper 12 is at the desired level.

Exit air temperature, which may sometimes be designated T1 in the attached claims, is measured by either temperature sensor 28 or temperature sensor 30 and is recorded by microprocessor 22. At the same time, air flow rate out of hot air outlet conduit 50 is computed using the measured air speed provided by outlet air speed detector 54 and the known dimensions of hot air outlet conduit 50.

The desired throughput of granular polymeric resin material being dried in hopper 12 is maintained and temperature of air exiting hopper 12 via hot air outlet conduit 50 is continuously measured until the temperature of air exiting hopper 12 via hot air outlet conduit 50 is stable. This hot air exit temperature is preferably recorded and preferably noted as being the stable temperature by microprocessor 22 and may be designated T2.

Microprocessor 22 controlling blower 36, preferably incrementally reduces air flow rate into hopper 12 via hot air supply line 48 until the temperature of air exiting hopper 12 via hot air outlet conduit 50 falls below recorded stable exit air temperature T2. Microprocessor 22 then incrementally increases air flow rate by increasing the speed of blower 36, thereby forcing more hot air flowing through hot air supply line 48 and into hopper 12 to pass through the granular polymeric resin material therein and then to exit from hopper 12 via hot air outlet conduit 50, until the measured exit air temperature, as measured either by sensor 28 or sensor 30, returns to temperature T2 measured at the stable condition. At that time microprocessor 22 computes exiting air flow rate through hot air outlet conduit 50 using outlet air speed detector 54 and records that computed air flow rate at the stable temperature T2 condition as S2. Microprocessor 22 thereafter either intermittently or continuously monitors outlet air flow rate for variance from the computed air flow rate S2 and makes air flow rate return to S2 by adjusting the speed of blower 36. Microprocessor 22 also either intermittently or continuously monitors exit air temperature as measured by sensors 28 and/or 30 and if measured exit air temperature is outside a predetermined range, microprocessor 22 adjusts the air flow rate by varying the speed of blower 36 until exit heating air temperature is within the predetermined range.

When drying most granular polymeric resin materials, the selected air flow rate at the commencement of operation is usually computed as being 0.6 cubic feet per minute per pound per hour of granular polymeric resin material to be dried, where the weight in pounds per hour of granular polymeric material to be dried is selected as the desired throughput for dryer 10.

In FIG. 1 the letters Gᵢₙ and Gₒᵤₜ indicate that the granular polymeric material to be dried is introduced into the top of hopper 12 through granular polymeric resin material inlet conduit 14 and the dried granular polymeric material is discharged from the bottom of hopper 12 via granular polymeric resin material outlet conduit 18.

Granular polymeric resin material to be dried is preferably continuously introduced into hopper 12 at the desired rate of throughput of the granular polymeric resin material and is released from hopper 12 at the desired throughput rate. In other words, in the preferred operation of dryer 10, once the system has started and stable conditions have been attained for the heating air outlet temperature and the air flow through hopper 12, operation thereafter continues with the preferable continuous flow of granular polymeric resin material being heated during passage through hopper 12.

As noted above, the ratio of air flow rate in cubic feet per minute per pound per hour of granular polymeric material to be dried is typically set at 0.6 for initial operation of dryer 10. Heated air outlet temperature is monitored by microprocessor 22 receiving data from temperature sensor 28 or 30; heated air outlet temperature is preferably monitored constantly. If air outlet temperatures are, on average, higher than what experience has proven to be desirable for a given polymer, then both an operator and microprocessor 22 know that the 0.6 ratio of cubic feet per minute of air flow per pound per hour of granular polymeric resin material throughput is incorrect for that particular polymer and current environmental conditions.

Monitoring exit air temperature allows microprocessor 22 to adjust the 0.6 ratio in gradual increments so that on average the exit air temperature is held at the desired level for the granular polymeric resin material being dried. Using this approach of making small and gradual adjustments to the air flow rate/throughput ratio in software resident within and executed by microprocessor 22, and making small up and down adjustments in the speed of blower 36 based on feedback provided in the form of heating air outlet temperature and flow rate of heating air leaving hopper 12 via hot air outlet conduit 50, allows maintenance of a substantially uniform air flow rate during normal minute-by-minute and hour-by-hour variations in the process, which inevitably occur due to environmental and other factors.

By microprocessor 22 monitoring air flow rate of air exiting hopper 12 via hot air outlet conduit 50, if microprocessor 22 detects a change, microprocessor 22 adjusts the speed of blower 36 to return to the correct rate of air flow in cubic feet per minute exiting through hot air outlet conduit 50. Then, as microprocessor 22 is monitoring the exit air temperature while making the small adjustments noted above, over time microprocessor 22 learns and records whether the air flow goal amount of hot air through outlet conduit 50 in cubic feet per minute is correct for the particular granular polymeric resin material being dried and the current environmental conditions such as ambient temperature and relative humidity in the facility in which dryer 10 is located. If exit temperature is too high, this indicates energy usage is excessive.

In the course of detecting any excess heat over time, microprocessor 22 will gradually reduce the hot air requirement in cubic feet per minute by slowing blower 36 to a target cubic feet per minute air flow rate out of hot air conduit 50. The targeted cubic feet per minute air flow rate may be adjusted gradually, perhaps over several hours, to hold an average target air temperature for hot air exiting hopper 12 via hot air outlet conduit 50.

The ratio in cubic feet per minute of air flow to pound per hour of granular polymeric resin material throughput, in the software of microprocessor 22, is adjustable.

With this approach, microprocessor 22 uses the air flow rate information in cubic feet per minute out of hot air outlet conduit 50 to adjust speed of blower 36. Inlet temperature is held constant for a given polymer or other granular polymeric resin material being dried. Adjustments to the speed of blower 36 are made only after steady temperatures are maintained in heating air exiting hot air outlet conduit 50. Once substantially constant temperature at hot air outlet conduit 50 has been reached, air flow rate in cubic feet per minute is calculated for heating air exiting hopper 12 via hot air outlet conduit 50. Microprocessor 22 then alters speed of blower 36 in small increments, and may make corresponding small adjustments in power provided by transformer 24 to heater 26, in order to return heating air flow rate in cubic feet per minute out of hot air outlet conduit 50 back to the targeted air flow rate in cubic feet per minute. Over time, if the temperature of heating air exiting hot air outlet conduit 50 has reached a higher level than desired, or never reaches the minimum level required, the target cubic feet per minute is adjusted by microprocessor 22 altering the speed of blower 36, with such adjustments being made incrementally until temperature of heating air exiting hot air outlet conduit 50 falls into line with expectations.

Microprocessor 22, being connected to blower 36, inlet heating air temperature sensor 32, and outlet air speed detector 54 including temperature sensors 28 and 30, which are a part of outlet air speed detector 54, controls blower speed in response to measured air speed to maintain heating air exit temperature at a selected level, to provide minimal energy usage by heating air heater 26. Microprocessor 22 periodically incrementally increases and decreases speed of blower 36, and regulates transformer 24, as needed, measures heating air exit temperature, as detected by one of temperature sensors 28 and 30, and computes heating air outlet flow rate until both are stable, and increases or decreases speed of blower 36 according to the measured stable heating air exit temperature being higher or lower than a preceding stable heating air exit temperature. This procedure may be repeated over a substantial time period, namely days or even weeks, to be sure the ideal speed for blower 36 had been determined for a given granular polymeric material and for a given set of environmental conditions.

While the invention has been disclosed in detail for dryers in a configuration with granular polymeric resin material to be dried moving constantly through dryer 10, the inventive concepts are equally applicable to batch drying granular material, and dryer 10 may equally well be used for batch drying.

As discussed above and from the foregoing description of the exemplary embodiments of the invention, it will be readily apparent to those skilled in the art to which the invention pertains that the principles, structures and methods, disclosed herein can be used for applications other than those specifically mentioned. All such applications of the invention are intended to be covered by the appended claims unless expressly excluded therefrom.

The invention may be embodied in other specific forms without departing from the spirit or essential characteristics of the invention. The disclosed embodiments are therefore to be considered in all respects as illustrative and not restrictive with the scope of the invention being indicated by the appended claims and equivalents, rather than by the foregoing description. All changes from the disclosed exemplary embodiments of the invention which come within the meaning and range of equivalents to the claims are therefore intended to be embraced therein. Specifically, embodiments and implementations performing substantially the same function in substantially the same way to achieve the same result are embraced by the claims.

As used in the claims herein, the term “comprising” means “including” while the term “consisting of” means “including so much and no more” and the term “consisting essentially of” means including the recited elements and those minor accessories appurtenant thereto which are known in the art to be required to facilitate the invention as claimed.

The following is claimed:

1. A method for hot air drying granular material in a hopper having a granular material inlet and a heating air outlet, and a granular material outlet and a heating air inlet, comprising:
a. introducing heating air into the hopper
b. recording heating air temperature at the heating air outlet;
c. computing heating air flow rate through the hopper;
d. recording the stable heating air outlet temperature;
e. incrementally reducing air flow rate through the hopper until heating air outlet temperature falls below the recorded stable heating air outlet temperature;
f. incrementally increasing air flow rate until heating air outlet temperature returns to the recorded stable heating air outlet temperature;
g. computing air flow rate through the hopper;
h. continuously monitoring air flow rate through the hopper for variance from the computed air flow rate through the hopper and adjusting air flow rate through the hopper to return to the computed air flow rate;
i. continuously monitoring heating air outlet temperature and if heating air outlet temperature is outside a predetermined range repeating step “h” until heating air outlet temperature is within a predetermined range of the recorded stable heating air outlet temperature.

2. The method of claim 1 further comprising maintaining the desired throughput of granular material being dried in the hopper while performing the steps of claim 1.

3. A dryer for granular material comprising:
a. a heating hopper having a granular material inlet and a heating air outlet proximate the hopper top, and a granular material outlet and a heating air inlet proximate the hopper bottom;
b. a blower;
c. a conduit connecting the blower to the heating air inlet of the hopper;
d. an air speed detector including a heating air outlet temperature sensor in the heating air outlet;
e. a microprocessor connected to the blower, the temperature sensor, and the air speed detector, controlling blower speed in response to detected air speed to maintain heating air exit temperature at a selected level providing minimal energy usage by the heating air heater by periodically incrementally increasing and decreasing blower speed, measuring hearing air exit temperature and air flow rate when both are stable, and increasing or decreasing blower speed according to the measured stable heating air exit temperature being higher or lower than a preceding measured stable heating air exit temperature.

4. The dryer of claim 3 wherein the air speed detector further comprises:
a. a second heating air outlet temperature sensor; and
b. a heater positioned between the two outlet air temperature sensors.

5. The dryer of claim 3 further comprising a heater in the conduit.

6. The dryer of claim 3 further comprising a scale, connected to the microprocessor, for detecting weight of heated granular material exiting the hopper via the granular material outlet.

7. The dryer of claim 5 further comprising a transformer connected to the microprocessor and the heater, for furnishing electrical power to the heater.

8. A method for continuous hot air drying of granular material comprising:
a. selecting a desired granular material throughput rate;
b. selecting a desired inlet heating air temperature;
c. using the selected granular material throughput rate, calculating the heating air flow rate required to deliver sufficient heat to the granular material to raise the temperature of exiting granular material to a level at which the granular material is adequately dry;
d. monitoring temperature of heating air leaving the granular material;
e. drying the granular material by blowing heating air therethrough at the calculated air flow rate until temperature of heating air leaving the granular material is steady within a preselected range;
f. determining rate of heating air flow through the granular material from temperature of heating air leaving the granular material;
g. adjusting heating air flow rate until actual heating air flow rate through the granular material equals the calculated heating air flow rate.

9. The method of claim 8 further comprising:
a. continuously monitoring temperature of heating air leaving the granular material; and
b. if temperature of heating air exiting the granular material is outside a preselected range incrementally adjusting heating air flow rate until temperature of heating air leaving the granular material is within the preselected range.

10. A method for hot air drying granular polymeric resin material, comprising:
a. setting an input air temperature control to a desired temperature for the granular polymeric resin material to be dried;
b. selecting a desired rate of throughput of granular polymeric resin material to be dried in pounds per hour;
c. blowing heating air at the desired temperature and at a selected air flow rate into the bottom of a hopper in which the granular polymeric material is to be dried;
d. monitoring temperature of air exiting the hopper;
e. checking the granular polymeric material exiting the hopper for moisture and if found to be too moist, incrementally increasing the heating air flow rate into the bottom of the hopper until moisture lever in granular polymeric material exiting the hopper is at the desired level;
f. recording heating air exit temperature (T1) and computing air flow rate (S1);
g. maintaining the desired throughput of granular polymeric material being dried in the hopper until heating air exit temperature is stable;
h. recording exit air temperature (T2);
i. incrementally reducing air flow rate until heating air exit temperature of hopper falls below T2;
j. incrementally increasing air flow rate until heating air exit temperature returns to T2;
k. computing air flow rate (S2);
l. continuously monitoring air flow rate for variance from S2 and adjusting air flow rate to return to S2;
m. continuously monitoring heating air exit temperature and outside a predetermined range repeating step “1” until heating air exit temperature is within the predetermined range.

11. The method of claim 10 wherein the selected air flow rate in step “c” is 0.6 cubic feet per minute per pound per hour of granular polymeric material to be dried.

12. The method of claim 10 wherein granular polymeric material to be dried is introduced into the top of the hopper and the dried granular polymeric material is received from the bottom of the hopper.

13. The method of claim 10 wherein temperatures are sensed and air flow rates are controlled by a microprocessor.

14. The method of claim 10 further comprising maintaining desired throughput of granular polymeric material being dried in the hopper while performing steps “h” through “m”.

15. The method of claim 10 further comprising continuously introducing granular polymeric material into the hopper at the desired rate of throughput of granular polymeric material and releasing the heated granular polymeric material from the hopper at the desired throughput rate.
